(19) United States
(12) Patent Application Publication
(10) Pub. No.: US 2025/0273725 A1
(43) Pub. Date: Aug. 28, 2025

(54) MANDREL UNIT, JELLYROLL FORMING METHOD, ELECTRODE ASSEMBLY, AND SECONDARY BATTERY

(71) Applicant: Samsung SDI Co., Ltd., Yongin-si (KR)

(72) Inventor: Boo Kyoung Moon, Suwon-si (KR)

(73) Assignee: Samsung SDI Co., Ltd., Yongin-si (KR)

(21) Appl. No.: 19/061,895

(22) Filed: Feb. 24, 2025

(30) Foreign Application Priority Data
Feb. 26, 2024 (KR) 10-2024-0027216

(51) Int. Cl. H01M 10/04; H01M 10/0587

(52) U.S. Cl. CPC H01M 10/0409; H01M 10/0587

(57) ABSTRACT

Disclosed herein are a mandrel unit including a reinforcement member capable of preventing deformation of a jellyroll and reform collapse, a jellyroll forming method, an electrode assembly, and a secondary battery. The mandrel unit includes: a mandrel winding an electrode assembly secured to one region thereof in one direction; and a reinforcement member mounted in one region of the mandrel and securing the electrode assembly to the mandrel.

### CROSS-REFERENCE TO RELATED APPLICATIONS

This present application claims priority to and the benefit under 35 U.S.C. § 119 (a)-(d) of Korean Patent Application No. 10-2024-0027216, filed on Feb. 26, 2024, in the Korean Intellectual Property Office, the entire disclosure of which is incorporated herein by reference.

### FIELD

Aspects of embodiments of the present disclosure relate to a mandrel unit, a jellyroll forming method, an electrode assembly, and a secondary battery.

### BACKGROUND

Secondary batteries can be charged and discharged unlike primary batteries that cannot be re-charged. Low-capacity secondary batteries are used in small, portable electronic devices, such as smartphones, feature phones, notebook computers, digital cameras, and camcorders, and high-capacity secondary batteries are widely used as power sources for motors in hybrid and electric vehicles and as power storage cells. Such a secondary battery includes an electrode assembly including a cathode and an anode, a case receiving the electrode assembly, and electrode terminals connected to the electrode assembly.

Such secondary batteries may be categorized into coil, cylindrical, prismatic, and pouch type batteries based on the shape of the case.

### SUMMARY

Aspects of embodiments of the present disclosure provide a mandrel unit, a jellyroll forming method, an electrode assembly, and a secondary battery including a reinforcement member that may address deformation of a winding core of a jellyroll.

According to some embodiments, a mandrel unit includes a mandrel winding an electrode assembly secured to one region thereof in one direction, and a reinforcement member mounted in one region of the mandrel and securing the electrode assembly to the mandrel.

According to exemplary embodiments of a jellyroll forming method, a jellyroll is formed using the mandrel unit described above.

According to some embodiments, an electrode assembly includes a jellyroll formed by winding a laminate including an anode, a cathode, and a separator interposed between the anode and the cathode, and a reinforcement member placed at a winding core of the jellyroll and supporting the winding core.

According to some embodiments, a secondary battery includes a jellyroll formed by winding a laminate including an anode, a cathode, and a separator interposed between the anode and the cathode into a jellyroll shape, and a reinforcement member placed at a winding core of the jellyroll and supporting a shape of the winding core.

According to some embodiments, a reinforcement member may prevent deformation and/or reform collapse of a winding core of a jellyroll, a mandrel unit, a jellyroll forming method, an electrode assembly, and a secondary battery.

According to some embodiments, a reinforcement member may reduce a risk of short circuit, a mandrel unit, a jellyroll forming method, an electrode assembly, and a secondary battery.

However, aspects and features of the invention are not limited to those described above and other aspects and features not mentioned will be clearly understood by those skilled in the art from the detailed description given below.

### BRIEF DESCRIPTION OF THE DRAWINGS

The following drawings attached to this specification illustrate embodiments of the present disclosure, and further describe aspects and features of the present disclosure together with the detailed description of the present invention. Thus, the present disclosure should not be construed as being limited to the drawings:

FIG. 1 is a perspective view of an exemplary cylindrical battery according to some embodiments;

FIG. 2 is a cross-sectional view of the exemplary cylindrical battery of FIG. 1 according to some embodiments;

FIG. 3 illustrates deformation that can occur in a winding core of a jellyroll.

FIG. 4 is a flowchart illustrating a jellyroll forming method according to some embodiments;

FIG. 5 is a view of aspects of an exemplary mandrel unit according to some embodiments;

FIG. 6A and FIG. 6B are views of the mandrel of FIG. 5 according to some embodiments;

FIG. 7 is a view of a jellyroll form according to some embodiments;

FIG. 8A and FIG. 8B are views of jellyroll forms according to some embodiments;

FIG. 9A and FIG. 9B are views of a mandrel unit according to some embodiments;

FIG. 10 is a perspective view of a battery module according to some embodiments;

FIG. 11 is a perspective view of a battery pack according to some embodiments;

FIG. 12 is a perspective view of a battery pack according to some embodiments;

FIG. 13 is a perspective view of a vehicle body of an automobile according to some embodiments; and

FIG. 14 is a side view of the vehicle body of FIG. 13 according to some embodiments.

### DETAILED DESCRIPTION

Hereinafter, exemplary embodiments of the present disclosure will be described, in detail, with reference to the accompanying drawings. The terms or words used in this specification and claims should not be construed as being limited to the usual or dictionary meaning and should be interpreted as having meanings and concepts consistent with the technical idea of the present disclosure based on the principle that the inventor can be his/her own lexicographer to appropriately define the concept of the term to explain his/her invention in the best way. The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof. Further, the use of “may” when describing embodiments of the present invention relates to “one or more embodiments of the present invention.”

In the figures, dimensions of the various elements, layers, and the like may be exaggerated for clarity of illustration. The same reference numerals designate the same elements.

References to two compared elements, features, and the like as being “the same,” may mean that they are “substantially the same.” Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

It will be understood that, although the terms first, second, third, and the like may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Throughout the specification, unless specified otherwise, each element may be singular or plural.

When an arbitrary element is referred to as being disposed (or placed or disposed) “above” (or “below”) or “on” (or “under”) a component, it may mean that the arbitrary element is placed in contact with the upper (or lower) surface of the component and may also mean that another component may be interposed between the component and any arbitrary element disposed (or placed or disposed) on (or under) the component.

In addition, it will be understood that, when an element is referred to as being “coupled,” “linked” or “connected” to another element, the elements may be directly “coupled,” “linked” or “connected” to each other, or an intervening element may be present therebetween, through which the element may be “coupled,” “linked” or “connected” to another element. In addition, when a part is referred to as being “electrically coupled” to another part, the part can be directly connected to another part or an intervening part may be present therebetween such that the part and another part are indirectly connected to each other.

Throughout the specification, when “A and/or B” is stated, it means A, B or A and B, unless specified otherwise. That is, “and/or” includes any or all combinations of a plurality of items enumerated. When “C to D” is stated, it means C or more and D or less, unless specified otherwise.

The terminology used herein is for the purpose of describing embodiments of the present disclosure and is not intended to limit the present disclosure.

Cylindrical batteries have a structure in which a wound electrode assembly, that is, a jellyroll, is inserted into a cylindrical can-shaped case. Due to winding characteristics of the jellyroll, a hollow space is formed at a center thereof, that is, at a winding core thereof. When the jellyroll expands and/or contracts due to the hollow space, stress accumulates in the winding core. As a result, the jellyroll can suffer from inward deformation of the winding core.

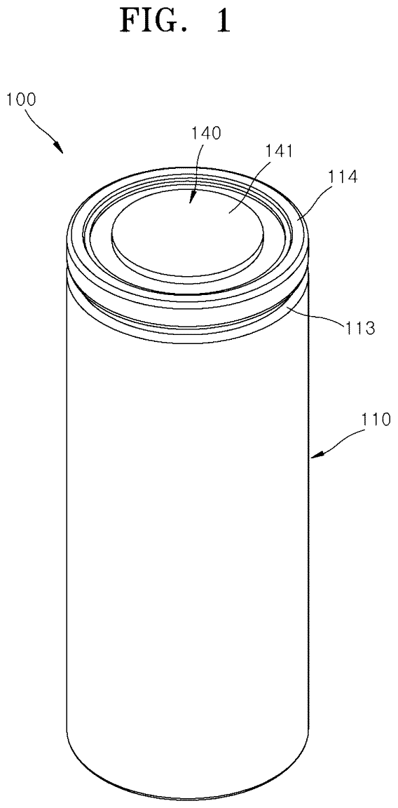

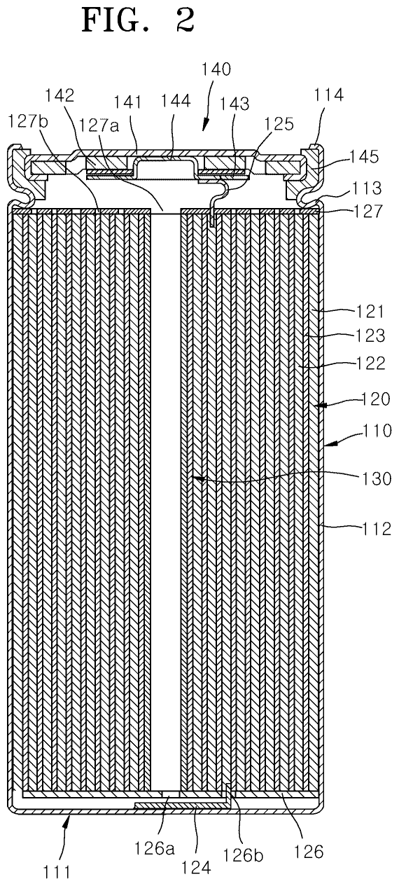

FIG. 1 is a perspective view of an exemplary cylindrical lithium ion secondary battery 100 according to some embodiments. FIG. 2 is a cross-sectional view of the exemplary cylindrical battery 100 according to some embodiments.

Referring to FIG. 1 and FIG. 2, the cylindrical lithium ion secondary battery 100 may include a cylindrical can 110, an electrode assembly 120, and a cap assembly 140. The cylindrical lithium ion secondary battery 100 may further include a center pin 130. Furthermore, in the secondary battery 100 according to the embodiments of the invention, the cap assembly 140 also performs current interruption and is thus often referred to as a current interrupt device.

The cylindrical can 110 may include a substantially circular bottom 111 and a cylindrical sidewall 112 extending a certain length upwards from a circumference of the bottom 111. During a manufacturing process of the secondary battery 100, an upper portion of the cylindrical can 110 is open. Thus, during an assembly process of the secondary battery 100, the electrode assembly 120 and the center pin 130 may be inserted into the cylindrical can 110 together with an electrolyte. The cylindrical can 110 may be formed of, for example, steel, stainless steel, aluminum, aluminum alloys, or an equivalent thereto, without being limited thereto.

In addition, the cylindrical can 110 may include a beading portion 113 recessed inwards at a lower portion thereof and a crimping portion 114 bent inwards at an upper portion thereof with respect to the cap assembly 140 to prevent the cap assembly 140 from being detached outwards.

The electrode assembly 120 may be received within the cylindrical can 110. The electrode assembly 120 may include an anode plate 121 having an anode active material (for example, graphite, carbon, and the like) coated on an anode current collector, a cathode plate 122 having a cathode active material (for example, a transition metal oxide (LiCoO₂, LiNiO₂, LiMn₂O₄, and the like)) coated on a cathode current collector, and a separator 123 interposed between the anode plate 121 and the cathode plate 122 to prevent short circuit while allowing only migration of lithium ions. Further, the anode plate 121, the cathode plate 122, and the separator 123 may be wound in a substantially cylindrical shape. By way of example, the anode current collector may be formed of copper (Cu) foil, the cathode current collector may be formed of aluminum (Al) foil, and the separator may be formed of polyethylene (PE) or polypropylene (PP) without being limited thereto.

In addition, an anode tab 124 may be welded to the anode plate 121 to protrude a certain length downwards and a cathode tab 125 may be welded to the cathode plate 122 to protrude a certain length upwards, or vice versa. By way of example, the anode tab 124 may be formed of copper (Cu) or nickel (Ni) and the cathode tab 125 may be formed of aluminum (Al), without being limited thereto.

In addition, the anode tab 124 of the electrode assembly 120 may be welded to the bottom 111 of the cylindrical can 110. Accordingly, the cylindrical can 110 may act as an anode. It should be understood that the cathode tab 125 may be welded to the bottom 111 of the cylindrical can 110 to act as a cathode.

In addition, a first insulating plate 126 coupled to the cylindrical can 110 and formed with a first hole 126a at a center thereof and a second hole 126b at a periphery thereof may be interposed between the electrode assembly 120 and the bottom 111. The first insulating plate 126 serves to prevent the electrode assembly 120 from electrically contacting the bottom 111 of the cylindrical can 110. In particular, the first insulating plate 126 serves to prevent the cathode plate 122 of the electrode assembly 120 from electrically contacting the bottom 111. Here, the first hole 126a serves to allow a gas to rapidly flow upwards through the center pin 130 in the event of generation of a large amount of gas due to an abnormality in the secondary battery 100, and the second hole 126b serves to allow the anode tab 124 to be welded to the bottom 111 therethrough.

In addition, a second insulating plate 127 coupled to the cylindrical can 110 and formed with a first hole 127a at a center thereof and a plurality of second holes 127b on a periphery thereof may be interposed between the electrode assembly 120 and the cap assembly 140. The second insulating plate 127 serves to prevent the electrode assembly 120 from electrically contacting the cap assembly 140. In particular, the second insulating plate 127 serves to prevent the anode plate 121 of the electrode assembly 120 from electrically contacting the cap assembly 140. Here, the first hole 127a serves to allow a gas to rapidly flow into the cap assembly 140 in the event of generation of a large amount of gas due to an abnormality in the secondary battery, and one of the second holes 127b serves to allow the cathode tab 125 to be welded to the cap assembly 140 therethrough. In addition, the remaining second holes 127b serve to allow the electrolyte to rapidly flow into the electrode assembly 120 during an electrolyte injection process.

Furthermore, the first holes 126a, 127a of the first and second insulating plates 126, 127 may have smaller diameters than the center pin 130 to prevent the center pin 130 from electrically contacting the bottom 111 of the cylindrical can 110 or the cap assembly 140 due to external impact.

The center pin 130 may be prepared in the form of a hollow circular pipe, which may be coupled substantially to the center of the electrode assembly 120. Such a center pin 130 may be formed of, for example, steel, stainless steel, aluminum, aluminum alloys, or polybutylene terephthalate, without being limited thereto. The center pin 130 serves to suppress deformation of the electrode assembly 120 during charging and discharging of the battery and acts as a flow conduit for gases generated within the secondary battery. Of course, in some embodiments, the center pin 130 may be omitted.

The cap assembly 140 may include a top plate 141, a middle plate 142, an insulating plate 143, and a bottom plate 144.

The middle plate 142 is disposed under the top plate 141 and may have a substantially flat shape.

The insulating plate 143 may be formed in a circular ring shape having a constant width in bottom view. In addition, the insulating plate 143 serves to insulate the middle plate 142 and the bottom plate 144 from each other. The insulating plate 143 may be, for example, interposed between the middle plate 142 and the bottom plate 144 and may be ultrasonically welded thereto, without being limited thereto.

However, it should be understood that the present invention is not limited thereto and the case may have various shapes, such as a circular shape, a pouch shape, and the like, and may be formed of metal, such as aluminum, aluminum alloys, and nickel-plated steel, a laminate film constituting a pouch, or plastics, without being limited thereto.

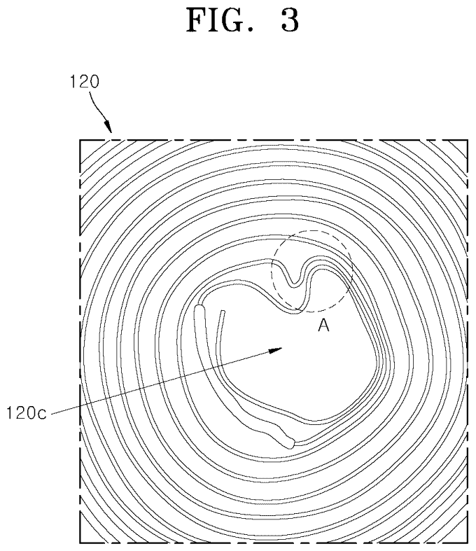

FIG. 3 is a view illustrating deformation that can occur in a winding core of a jellyroll.

In FIG. 3, an electrode assembly 120 is shown. As illustrated in FIG. 1 and FIG. 2, the jellyroll refers to a structure formed by winding the electrode assembly 120. The jellyroll includes a hollow winding core 120c at a winding center thereof.

The hollow winding core can be deformed, as shown, due to impact or continuous stress accumulation. For example, as indicated by A of FIG. 3, short circuit can occur at a start point of a cathode in the electrode assembly 120 (including, for example, the cathode plate 122 illustrated in FIG. 1 and FIG. 2). Alternatively, as indicated by A of FIG. 3, an anode of the electrode assembly 120 (including, for example, the anode plate 121 illustrated in FIG. 1 and FIG. 2) can undergo non-slipping to be bent in a z-shape. Such short circuit and/or non-slipping can occur as the anode expands and/or the cathode/anode shifts during an electrolyte filling process. Such short circuit and/or non-slipping can occur as a friction zone increases with longer alignment.

In this case, there is a problem of collapse of the separator during a reforming process and/or tab welding. In addition, short circuit can occur inside the jellyroll (wound electrode assembly 120).

Thus, the inventors have recognized that a technique that allows an electrode assembly 200 to form a jellyroll form without deformation at a winding core 200c, as detailed below, may be desirable. The electrode assembly 200 includes a reinforcement member 400, as detailed below.

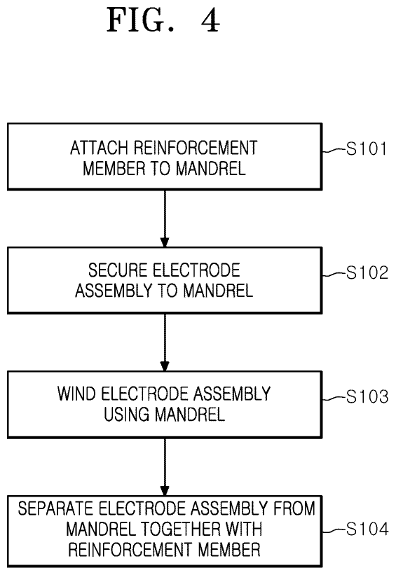

FIG. 4 is a flowchart illustrating a jellyroll forming method according to some embodiments.

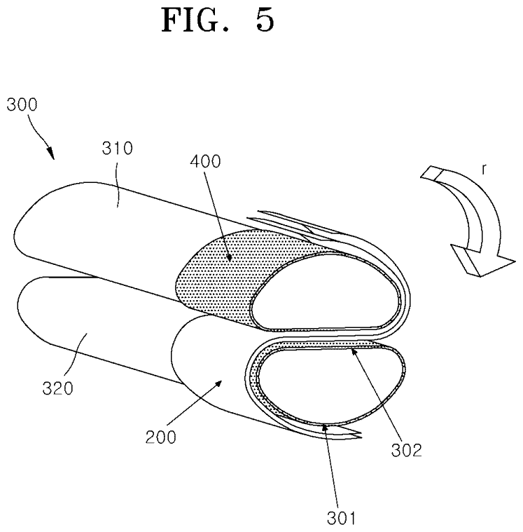

FIG. 5 is a view of aspects of an exemplary mandrel unit 300 according to some embodiments.

Referring to FIG. 4 and FIG. 5, an exemplary method for forming a jellyroll form capable of preventing deformation at a winding core 200c is described according to some embodiments. A mandrel unit 300, according to some embodiments, facilitates preventing deformation of the jellyroll form of the electrode assembly 200. The mandrel unit 300 may include a mandrel 310, 320 and reinforcement member 400. For example, the mandrel 310, 320 may have a first mandrel 310. For example, the mandrel 310, 320 may have a second mandrel 320. For example, the mandrel 310, 320 may have the first mandrel 310 and the second mandrel 320.

Referring to FIG. 4, the jellyroll forming method according to some embodiments includes mounting a reinforcement member 400 on the mandrel 310, 320 (S101).

The mandrel unit 300 facilitates winding a material into a coil shape for convenience of transportation, storage management, and the like. For example, the mandrel unit 300 facilitates winding the electrode assembly 200 in the form of a jellyroll.

An elongated material (having, for example, a sheet shape and including, for example, the electrode assembly 200) is wound around the mandrel unit 300. The elongated material is secured to one region of the mandrel 310, 320. The mandrel 310, 320 is rotated in one direction to wind the elongated material. A reinforcement member 400 may be formed to surround the mandrel 310, 320 along an outer circumferential surface thereof.

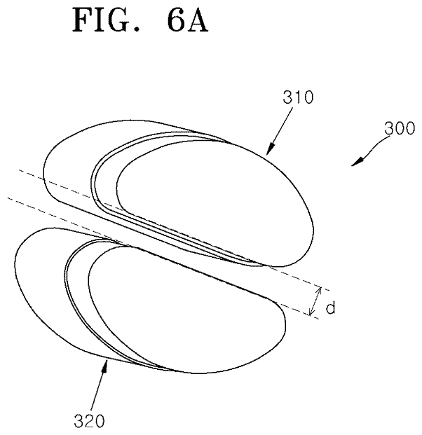

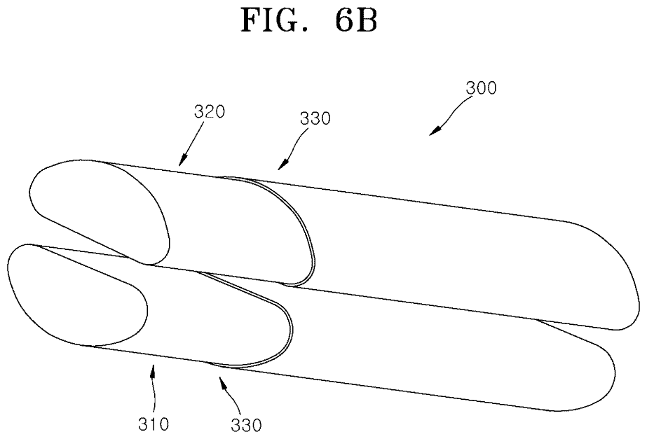

The outer circumferential surface of the mandrel 310, 320 includes a first surface portion 301 and a second surface portion 302. The first surface portion 301 is substantially curved. The elongated material is wound around the mandrel 310, 320 along the first surface portion 301 thereof. The second surface portion 302 is substantially flat. As shown, the mandrel 310, 320 includes the first mandrel 310 and the second mandrel 320, further discussed with reference to FIGS. 6A and 6B, each of which includes the first surface portion 301 and the second surface portion 302. The elongated material (electrode assembly 200) is inserted into a space between the second surface portion 302 of the first mandrel 310 and the second mandrel 320 (indicated by distance d in FIG. 6A) and secured to the mandrel 300.

The reinforcement member 400 forms a particular shape in a particular temperature range and/or in a particular pressure range. The reinforcement member 400 can shrink in a certain temperature range and/or in a certain pressure range and return to an original volume thereof when the temperature and/or the pressure of the reinforcement member is not in the certain temperature range and/or the certain pressure range. Further, the reinforcement member 400 may include a material that is at least partially flexible. In addition, the reinforcement member 400 may include a material that can be externally deformed by heat or stimulation but does not melt or allow property change upon application of heat or stimulation thereto.

For example, the reinforcement member 400 includes a shape memory alloy, a heat shrinkable tube, and an elastomer. The shape memory alloy includes, for example, Ni—Ti alloys, Cu—Zn—Al alloys, Cu—Al—Ni alloys, or alloys prepared by adding additives, such as Mg, Ti, or the like, to these alloys. The heat shrinkable tube includes a heat shrinkable material that decreases in volume at a certain temperature. The heat shrinkable tube includes, for example, a polyester resin, a polyolefin resin, a polyphenylene sulfide resin, and the like, and includes at least one selected from among, for example, polyvinyl chloride, polystyrene, polyethylene terephthalate, polyolefin, nylon, polyvinyl chloride, polybutylene terephthalate, and the like. The elastomer includes a tube having an elastic structure that recovers to a particular shape. The elastomer is formed of a material having elasticity, for example, latex and natural rubber.

The reinforcement member 400 may have a long side in a longitudinal direction thereof and a short side in a width direction thereto. The reinforcement member 400 may have, for example, a sheet shape. In addition, the reinforcement member 400 may be, for example, bent such that one side of the long side (i.e., one end) meets the other side of the long side (i.e., the other end) to form a ring shape.

The reinforcement member 400 may be mounted in one region of the mandrel 310, 320. For example, the reinforcement member 400 may surround the one region of the mandrel 310, 320 along the outer circumferential surface of the mandrel 310, 320. The one region of the mandrel 310, 320 includes, for example, an end portion of the mandrel 310, 320, as shown in FIG. 5. Further, the one region of the mandrel 310, 320 may include, for example, a region in which the elongated material is also wound around the mandrel 310, 320. Accordingly, as shown in FIG. 5, in the mandrel unit 300, the region of the mandrel 310, 320 in which the reinforcement member 400 is mounted may correspond at least partially to a region in which the electrode assembly 200 is fixedly wound.

The reinforcement member 400 may be tightly wound around the outer peripheral surface of the mandrel 310, 320 to be mounted thereon without any adhesive. In this case, adhesion between the reinforcement member 400 and the mandrel 310, 320 can be further improved by rotation of the mandrel 310, 320. Alternatively, the reinforcement member 400 may be mounted on the mandrel 310, 320 via an adhesive tape, an adhesive member, or the like.

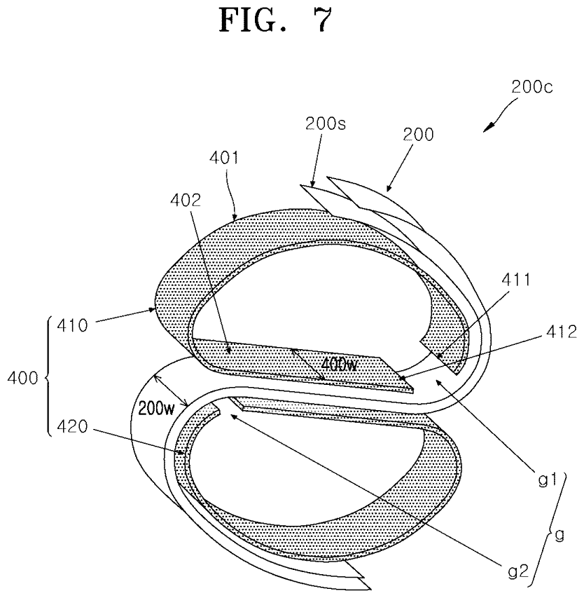

The reinforcement member 400 may be bent such that one side of the reinforcement member 400 (for example, one side of the long side or an end) faces the other side (i.e., end) of the reinforcement member 400 (for example, the other side of the long side) to form a ring shape on the outer circumferential surface of the mandrel 310, 320. In an exemplary case shown in FIG. 7, the one side of the reinforcement member 400 and the other side of the reinforcement member 400 may face each other without adjoining each other to form a slit g. The slit g is a gap formed between the one side of the reinforcement member 400 and the other side of the reinforcement member 400 (i.e., between the two ends). The reinforcement member 400 may surround one region of the mandrel 310, 320, with the slit g placed on or adjacent the second surface portion 302 of the mandrel 310, 320. With the slit g, the reinforcement member 400 may have a deformable structure.

On the other hand, the reinforcement member 400 may form a ring shape in which one side of the reinforcement member 400 and the other side of the reinforcement member 400 face each other while contacting each other without forming the slit g therebetween. In this case, a portion at which one side of the reinforcement member 400 and the other side of the reinforcement member 400 contact each other may be placed on or adjacent the second surface portion 302 of the outer circumferential surface of the mandrel 310, 320.

Returning to FIG. 4, the jellyroll forming method according to some embodiments may include securing an electrode assembly 200 to the mandrel unit 300 (S102).

The electrode assembly 200 may be an elongated sheet-like laminate including a cathode plate, a separator, and an anode plate. Specifically, the electrode assembly 200 may be formed by stacking an anode, a cathode, and the separator disposed between the anode and the cathode, as illustrated in FIG. 1 and FIG. 2.

The anode may include an anode base and an anode material layer disposed on the anode base. The anode material layer may include an anode material and may further include a binder and/or a conductive material. The cathode may include a cathode base and a cathode material layer disposed on the cathode base. The cathode base is, for example, a current collector. The cathode material layer may include a cathode material and may further include a binder and/or a conductive material. The separator may include polyethylene, polypropylene, polyvinylidene fluoride, or multilayer membranes thereof. The separator may include a porous base and a coating layer formed on one or both surfaces of the porous base and including an organic material, an inorganic material, or a combination thereof.

The electrode assembly 200 may be secured to the mandrel unit 300 through the reinforcement member 400. For example, the electrode assembly 200 may be secured to the mandrel 310, 320 on which the reinforcement member 400 is mounted. The electrode assembly 200 is inserted into (i.e., between the first mandrel 310 and the second mandrel 320) and secured to the mandrel 310, 320 on which the reinforcement member 400 is mounted. Alternatively, the electrode assembly 200 may be further secured to the mandrel unit 300 by being wound around the mandrel unit 300, with the end portion of one side of the electrode assembly 200 secured to the mandrel unit 300.

Referring to FIG. 4, the jellyroll forming method may include winding the electrode assembly 200 using the mandrel unit 300 (S103).

The mandrel unit 300 may be used to wind the electrode assembly 200 in one direction r. The one direction r may be the clockwise or counterclockwise direction. The mandrel unit 300 may be used to wind the electrode assembly 200 to form a jellyroll. With the electrode assembly 200 wound around the mandrel unit 300, the mandrel unit 300 with the reinforcement member 400 mounted on the mandrel 310, 320 may be placed at a winding core of the electrode assembly 200.

Referring to FIG. 4, the jellyroll forming method may include separating the electrode assembly 200 from the mandrel 310, 320 together with the reinforcement member 400 (S104).

The electrode assembly 200 may be separated from the mandrel 310, 320 in the form of a jellyroll (jellyroll-shaped electrode assembly). The electrode assembly 200 is separated from the mandrel 310, 320 together with the reinforcement member 400 such that the reinforcement member 400 is placed at the winding core of the jellyroll separated from the mandrel 310, 320. That is, the electrode assembly 200 includes the jellyroll form and the reinforcement member 400. The jellyroll is formed by winding the laminate (i.e., electrode assembly structure prior to being formed into the jellyroll) including the anode, the cathode, and the separator interposed between the anode and the cathode. According to embodiments of the method in FIG. 4, the reinforcement member 400 is placed at the winding core of the jellyroll to support the winding core.

In addition, the reinforcement member 400 may allow the electrode assembly 200 (electrode plates) to slip along a line of the reinforcement member 400 in the event of expansion and contraction of the jellyroll, thereby ensuring that a leading end of the electrode assembly 200 slips smoothly. Accordingly, the reinforcement member 400 may prevent deformation of the jellyroll. In addition, the reinforcement member 400 may prevent reform collapse when an anode tab (including, for example, the anode tab 124 illustrated in FIG. 1 and FIG. 2) is welded to the jellyroll.

As such, the jellyroll formed according to embodiments of the method in FIG. 4 and/or the jellyroll formed using the mandrel unit 300 according to some embodiments may minimize deformation and prevent reform collapse.

FIG. 6A and FIG. 6B are views of the mandrel unit 300 of FIG. 5 according to some embodiments.

In FIG. 6A and FIG. 6B, aspects of the structure of the mandrel unit 300 illustrated in FIG. 5 are detailed.

As shown in FIG. 6A, the mandrel unit 300 includes the mandrel 310, 320 with the first mandrel 310 and the second mandrel 320.

The first mandrel 310 and the second mandrel 320 are formed in a symmetrical shape with respect to each other. In addition, the first mandrel 310 and the second mandrel 320 face each other. That is, the first mandrel 310 and the second mandrel 320 have the same shape and are disposed in opposite directions.

Each of the first mandrel 310 and the second mandrel 320 includes a first surface portion 301 (see FIG. 5) and a second surface portion 302 (see FIG. 5). The second surface portion 302 of the first mandrel 310 and the second surface portion 302 of the second mandrel 320 face each other and are the closest parts of first mandrel 310 and the second mandrel 320 to each other.

The first mandrel 310 is spaced apart from the second mandrel 320 by a predetermined distance d. Thus, the second surface portion 302 of the first mandrel 310 and the second surface portion 302 of the second mandrel 320 are spaced apart from each other by the distance d while facing each other.

The reinforcement member 400 may be mounted on each of the first mandrel 310 and the second mandrel 320. For example, as shown in FIG. 7, the reinforcement member 400 may include a first reinforcement member 410 mounted on the first mandrel 310 and a second reinforcement member 420 mounted on the second mandrel 320. As shown, the first reinforcement member 410 may be mounted on an end of the first mandrel 310, and the second reinforcement member 420 may be mounted on a corresponding end of the second mandrel 320.

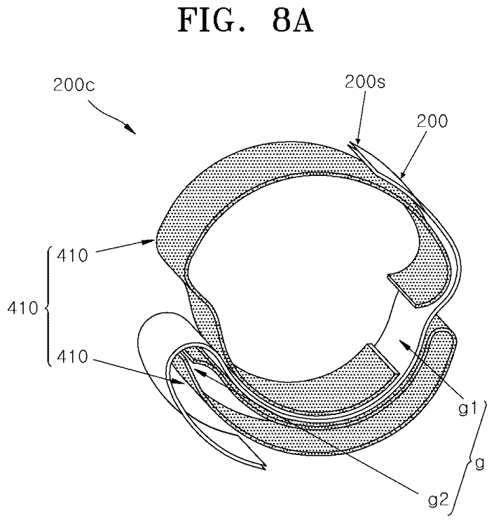

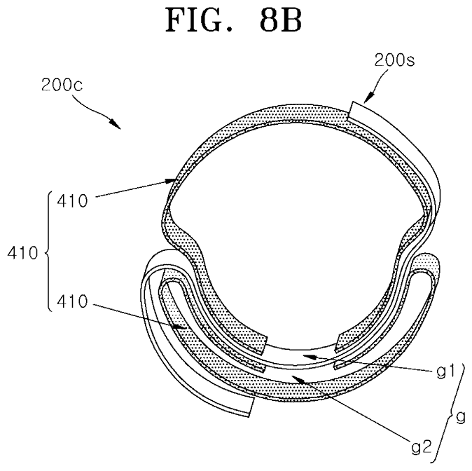

The electrode assembly 200 may be inserted into the gap (indicated by distance d) between the first mandrel 310 and the second mandrel 320. For example, the electrode assembly 200 may be inserted into the gap such that a leading end 200s (FIGS. 7, 8A) of the electrode assembly 200 is placed on the first surface portion 301 of the first mandrel 310 or the second mandrel 320, and a body of the electrode assembly 200, proximate to the leading end 200s, is interposed between the second surface portion 302 of the first mandrel 310 and the second surface portion 302 of the second mandrel 320. The leading end 200s of the electrode assembly 200 is one end of the electrode assembly 200 in a longitudinal direction thereof and is a portion of the electrode assembly 200 placed at the winding core of the jellyroll when the electrode assembly 200 forms the jellyroll. The body includes all portions of the electrode assembly 200 excluding the leading end 200s (and a trailing end) thereof.

The distance d may be greater than or equal to the sum of a thickness of the electrode assembly 200, a thickness of the first reinforcement member 410, and a thickness of the second reinforcement member 420.

The first mandrel 310 and the second mandrel 320 may be connected by a driver (not shown). The first mandrel 310 and the second mandrel 320 may be rotated together by the driver. For example, the first mandrel 310 and the second mandrel 320 may be rotated in one direction by the driver to wind the electrode assembly 200 secured to the mandrel 300.

Referring to FIG. 6B, the mandrel unit 300 includes a step region 330 in the first mandrel 310 and the second mandrel 320. The mandrel unit 300 includes the step region 330 corresponding to a space in which the reinforcement member 400 is mounted. For example, the mandrel unit 300 includes the step region 330 at a leading end of each of the first mandrel 310 and the second mandrel 320. The step region 330 is formed along the outer circumferential surface of each of the mandrel 310 and the second mandrel 320. An outer circumferential surface of the step region 330 is lower than the outer circumferential surface of the other region in each of the first mandrel 310 and the second mandrel 320. That is, the outer circumferential surface of the step region 330 has a smaller perimeter than the outer circumferential surface of the other region of the first mandrel 310 and the second mandrel 320. A thickness (width) of the step region 330 with respect to the longitudinal direction of the mandrels 310, 320 is the same or similar to a thickness (width) of the reinforcement member 400 mounted on the step region 330.

The reinforcement member 400 may be more easily secured to and/or mounted on the mandrel 310, 320 at the step region 330.

With such a structure, the mandrel unit 300 according some embodiments may form the jellyroll including the reinforcement member 400 at the winding core. Hereinafter, the jellyroll shown in FIG. 4 and FIG. 5 and a secondary battery including such a jellyroll are further described.

FIG. 7 is a view of a jellyroll form according to some embodiments.

FIG. 7 shows an exemplary winding core 200c of the jellyroll. The winding core 200c corresponds to a center of the jellyroll formed by winding the electrode assembly 200. The winding core 200c refers to a region in which the jellyroll form is released from the mandrel unit 300 and has a hollow center. The jellyroll may be formed with the reinforcement member 400 at the winding core 200c, according to the exemplary method of FIG. 4 and as shown in FIG. 5 to FIG. 6B.

As illustrated in FIG. 6A and FIG. 6B, the reinforcement member 400 may include a first reinforcement member 410 and a second reinforcement member 420.

The first reinforcement member 410 is placed at an upper portion of the winding core 200c and supports an upper shape of the jellyroll. A leading end 200s of the electrode assembly is placed on one surface of the first reinforcement member 410.

The first reinforcement member 410 includes a first surface portion 401 and a second surface portion 402 connected to the first surface 401. The first surface portion 401 of the first reinforcement member 410 is formed corresponding to the first surface portion 301 of the mandrel 310, 320 illustrated in FIG. 5, FIG. 6A and FIG. 6B. Accordingly, the first surface portion 401 of the first reinforcement member 410 is substantially curved. The second surface portion 402 of the first reinforcement member 410 is formed corresponding to the second surface portion 302 of the mandrel unit 300 illustrated in FIG. 5 FIG. 6A and FIG. 6B. Accordingly, the second surface portion 402 of the first reinforcement member 410 is substantially flat (e.g., curving at the ends as shown for the second surface portion 402 with the slit g1 in FIG. 7). The first surface portion 401 and the second surface portion 402 of the first reinforcement member 410 are connected to each other to form a ring shape, for example, similar to a half-moon.

The second surface portion 402 of the first reinforcement member 410 includes a first slit g1 formed in at least a portion thereof. As shown in FIG. 7, the first slit g1 is formed between the first end 411 and the second end 412 of the first reinforcement member 410 spaced apart from each other to face each other. The first slit g1 may be formed at any place, such as a center portion, a side portion, or the like, of the second surface portion 402, as shown in FIG. 7, so long as the first slit g1 is formed along the second surface portion 402 of the first reinforcement member 410. That is, the first slit g1 is formed in the first reinforcement member 410 towards the second reinforcement member 420 (to be close to the second reinforcement member 420).

As shown in FIG. 7, the leading end 200s of the electrode assembly 200 is placed on the first surface portion 401 of the first reinforcement member 410. The electrode assembly 200 extends from the first surface portion 401 of the first reinforcement member 410 to surround the first reinforcement member 410 along the second surface portion 402 of the first reinforcement member 410 and extends from the second surface portion 402 of the first reinforcement member 410 toward the first surface portion 401 of the second reinforcement member 420. In this way, the electrode assembly 200 surrounds the reinforcement member 400 to form the jellyroll.

The second reinforcement member 420 is placed at a lower portion of the winding core 200c and supports a lower shape of the jellyroll, according to the orientation shown in FIG. 7. The shape and arrangement of the second reinforcement member 420 is the same as or similar to that of the first reinforcement member 410. Accordingly, a second surface portion 402 of the second reinforcement member 420 may include a second slit g2 formed along or adjacent to the second surface portion 402 of the second reinforcement member 420. That is, the second slit g2 may be formed in the second reinforcement member 420 towards the first reinforcement member 410 (to be close to the first reinforcement member 410). The second slit g2 may be the same length or a different length than the first slit g1.

A length of the reinforcement member 400 in a transverse direction thereof is referred to as a width 400w of the reinforcement member 400, as indicated in FIG. 7. In addition, a length of the electrode assembly 200 in the transverse direction thereof is referred to as a width 200w of the electrode assembly 200, as indicated in FIG. 7.

The width 400w of the reinforcement member 400 may be less than or equal to the width 200w of the electrode assembly 200. With this structure, the reinforcement member 400 may eliminate inconvenience caused by the reinforcement member 400 during delivery or storage of the jellyroll.

Specifically, the width 400w of the reinforcement member may be less than or equal to the width of the separator 123 (not shown in FIG. 7) in the electrode assembly 200. Further, the width 400w of the reinforcement member may be greater than or equal to the width of the anode (not shown) in the electrode assembly 200. In this way, the reinforcement member 400 can efficiently support the winding core 200c of the jellyroll.

FIG. 8A and FIG. 8B are views of jellyroll forms according to some embodiments.

FIG. 8A and FIG. 8B show winding cores 200c of the jellyroll form. FIG. 8A shows an embodiment in which slits g (including first slit g1 and second slit g2) are formed at sides of the second surface portions 402 of the reinforcement member 400, and FIG. 8B shows an embodiment in which slits g are formed at a center of the second surface portions 402 of the reinforcement member 400.

Although FIG. 8A and FIG. 8B show exemplary embodiments in which the slits g of the first reinforcement member 410 and the second reinforcement member 420 are formed symmetrical with respect to each other (for example, point-symmetrical with respect to a point placed at the middle between the first reinforcement member 410 and the second reinforcement member 420), it should be understood that the present invention is not limited thereto. Accordingly, for example, a first slit g1 may be placed at a side of the second surface portion 402 of the first reinforcement member 410 and a second slit g2 may be placed at the center of the second surface portion 402 of the second reinforcement member 420.

The reinforcement member 400 may be deformed by external pressure or external temperature. As shown in FIG. 8A and FIG. 8B, both the first surface portions 401 and the second surface portions 402 of the reinforcement member 400 may be deformed into curved surfaces. When the reinforcement member 400 is deformed, the electrode assembly 200 slips along the shape of the reinforcement member 400. Here, the leading end 200s of the electrode assembly is placed on the first surface and the slits g are placed along the second surface. Accordingly, the leading end 200s of the electrode assembly 200 is not damaged and slips smoothly along the reinforcement member 400.

With this structure, the winding core 200c of the jellyroll form can be supported by the reinforcement member 400 without collapsing even when the jellyroll form (i.e., reinforcement member 400 and electrode assembly 200 in the jellyroll form) repeatedly contracts or expands.

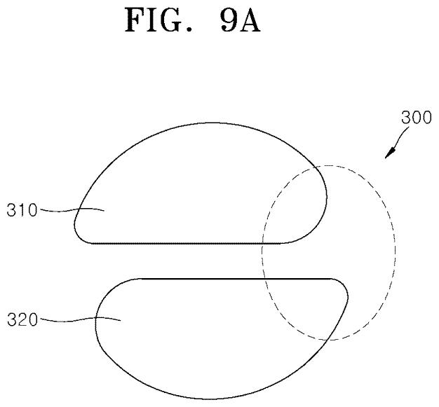

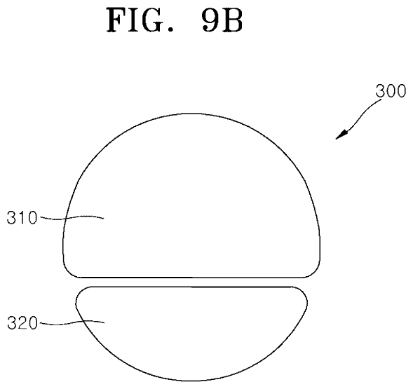

FIG. 9A and FIG. 9B are views of the mandrel unit 300 according to some embodiments.

FIG. 5 to FIG. 8B show the first mandrel 310 and the second mandrel 320 and/or the first reinforcement member 410 and the second reinforcement member 420, which are formed in a symmetrical structure. As described above, for example, the mandrel unit 300 according to some embodiments may include two mandrels 310, 320, which are not formed in a linearly symmetrical shape with respect to each other.

Referring to FIG. 9A, for example, the mandrel 300 according to some embodiments may include two mandrels 310, 320 formed in a point-symmetrical shape with respect to each other. For example, the first mandrel 310 and/or the second mandrel 320 may include a substantially curved surface and a substantially flat surface. The first mandrel 310 and/or the second mandrel 320 may include connection surfaces connecting (i.e., aligning) the curved surface to the flat surface, in which a connection surface at one side may have a small curvature and a connection surface at the other side may have a large curvature, as in the region indicated by the dashed line. Accordingly, the first mandrel 310 and/or the second mandrel 320 may be formed in a structure in which the connecting surface at one side is narrower or more pointed than the connecting surface at the other side. Here, one side of the first mandrel 310 and one side of the second mandrel 320 may be placed at a location to be point-symmetrical to each other with respect to a central point of the mandrel unit 300.

Alternatively, referring to FIG. 9B, for example, the mandrel unit 300 according to some embodiments may include two mandrels 310, 320 formed in different shapes and/or sizes. The first mandrel 310 may have a different size and shape than the second mandrel 320. For example, the first mandrel 310 may be larger than the second mandrel 320. For example, the first mandrel 310 and the second mandrel 320 may be formed in different shapes in which the flat surfaces of the first mandrel 310 and the second mandrel 320 have lengths corresponding to each other whereas the curved surfaces of the first mandrel 310 and the second mandrel 320 have different lengths. Alternatively, the first mandrel 310 and the second mandrel 320 may have different sizes and the same shape. Alternatively, the first mandrel 310 and the second mandrel 320 may have different shapes and the same size. As such, the embodiments of the present invention may provide a mandrel unit 300 with a mandrel 310, 320 including two mandrels 310, 320 that are not linearly symmetrical to each other and/or have different sizes and shapes.

As previously noted, the reinforcement member 400 according to some embodiments may include a first reinforcement member 410 and a second reinforcement member 420. The first reinforcement member 410 may be wound around the first mandrel 310 and the second reinforcement member 420 may be wound around the second mandrel 320.

Although not shown in FIG. 5 to FIG. 9B, the first reinforcement member 410 and the second reinforcement member 420 may have different shapes and/or different sizes based on the shapes and sizes of the two mandrels 310, 320. For example, when the first mandrel 310 is larger than the second mandrel 320, as shown in FIG. 9B, the first reinforcement member 410 may be longer than the second reinforcement member 420. As such, some embodiments may provide the reinforcement member 400 corresponding to the shape and/or size of the mandrel unit 300. Alternatively, the first reinforcement member 410 and the second reinforcement member 420 may have the same shape and/or the same size, even when the first mandrel 310 is larger than the second mandrel 320, as shown in FIG. 9B. As such, the embodiments of the present invention may provide the reinforcement member 400 that can be applied to a mandrel unit 300 having any size and/or shape.

A secondary battery according to some embodiments includes the jellyroll form and the reinforcement member 400 placed at the winding core 200c of the jellyroll and supporting the shape of the jellyroll. Further, the secondary battery 100 includes a case (for example, a cylindrical can 110, as shown in FIG. 1 and FIG. 2) into which the jellyroll form including the reinforcement member 400 and an electrolyte may be inserted.

Aspects of the secondary battery 100 according to some embodiments are described.

The jellyroll may be formed by winding the electrode assembly 200 as discussed with reference to FIGS. 4 to 9B. As previously noted with reference to electrode assembly 120 shown in FIGS. 1 and 2, the electrode assembly 200 may be formed by stacking an anode, a cathode, and a separator interposed between the anode and the cathode.

The anode includes an anode base and an anode material layer formed on the anode base. The anode base is, for example, an anode current collector. The anode material layer includes an anode material and may further include a binder and/or a conductive material. The anode material includes a material allowing reversible intercalation/deintercalation of lithium ions, lithium metal, lithium metal alloys, a material capable of being doped to lithium and de-doped therefrom, or a transition metal oxide.

The material allowing reversible intercalation/deintercalation of lithium ions may include a carbon anode material, for example, crystalline carbon, amorphous carbon, or a combination thereof. The crystalline carbon may include, for example, graphite, such as natural graphite and artificial graphite, and the amorphous carbon may include, for example, soft carbon, hard carbon, mesoporous pitch carbides, calcined coke, and the like.

The material capable of being doped to lithium and de-doped therefrom may be an Si anode material or an Sn anode material. The Si anode material may be silicon, a silicon-carbon composite, SiOₓ (0<x<2), Si alloys, or a combination thereof.

The silicon-carbon composite may be a composite of silicon and amorphous carbon. According to one embodiment, the silicon-carbon composite may be realized in the form of silicon particles and amorphous carbon-coated silicon particles.

The silicon-carbon composite may further include crystalline carbon. For example, the silicon-carbon composite may include a core containing crystalline carbon and silicon particles and an amorphous carbon coating layer formed on the core.

For example, the anode material layer may include 90 wt % to 99 wt % of the anode material, 0.5 wt % to 5 wt % of the binder, and optionally 5 wt % or less of the conductive material

The binder may be a non-aqueous binder, an aqueous binder, a dry binder, or a combination thereof. When the aqueous binder is used as the binder, the binder may further include a cellulose compound capable of imparting viscosity.

The anode current collector may be selected from among copper foil, nickel foil, stainless steel foil, titanium foil, nickel foam, copper foam, a polymer base coated with a conductive metal, and combinations thereof.

The cathode includes a cathode base and a cathode material layer formed on the cathode base. The cathode base is, for example, a current collector. The cathode material layer includes a cathode material and may further include a binder and/or a conductive material.

The current collector may be formed of Al, without being limited thereto.

As the cathode material, a compound enabling reversible intercalation and deintercalation of lithium (lithiated intercalation compound) may be used. Specifically, the cathode material may be at least one complex oxide of a metal selected from among cobalt, manganese, nickel and combinations thereof with lithium.

The composite oxide may be a lithium transition metal composite oxide. Specifically, the composite oxide may be a lithium nickel oxide, a lithium cobalt oxide, a lithium manganese oxide, a lithium iron phosphate compound, a cobalt-free nickel-manganese oxide, or a combination thereof.

By way of example, the composite oxide may be a compound represented by any of the following formulas: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}CO_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c<0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8).

In the above formulas, A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and

L′ is Mn, Al, or a combination thereof.

The cathode material may be present in an amount of 90 wt % to 99.5 wt % based on 100 wt % of the cathode material layer and each of the binder and the conductive material may be present in an amount of 0.5 wt % to 5 wt % based on 100 wt % of the cathode material layer.

The electrolyte for the lithium secondary battery includes a non-aqueous organic solvent and a lithium salt.

The non-aqueous organic solvent acts as a medium through which ions involved in electrochemical reaction of the battery can migrate.

The non-aqueous organic solvent may be a carbonate solvent, an ester solvent, an ether solvent, a ketone solvent, an alcohol solvent, a non-amphoteric solvent, or a combination thereof, and may be used alone or as a mixture thereof.

In addition, a mixture of cyclic and chain carbonates may be used as the carbonate solvent.

Depending on the type of lithium secondary battery, a separator may be interposed between the cathode and anode. The separator may include polyethylene, polypropylene, polyvinylidene fluoride, or multilayer membranes thereof.

The separator may include a porous base and a coating layer formed on one or both surfaces of the porous base and including an organic material, an inorganic material, or a combination thereof.

The organic material may include a polyvinylidene fluoride polymer or a (meth)acrylic polymer.

The inorganic material may include inorganic particles selected from among Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof, without being limited thereto.

The organic material and the inorganic material may be present in a mixed state in one coating layer or in the form of a stack structure of a coating layer containing the organic material and a coating layer containing the inorganic material.

Accordingly, one embodiment of the present invention may provide a secondary battery that can prevent deformation and/or reform collapse during anode-tap welding.

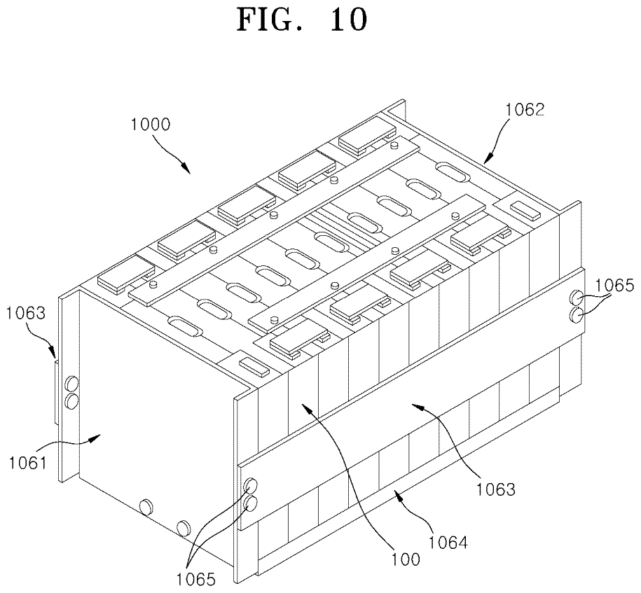

FIG. 10 is a perspective view of a battery module 1000 according to some embodiments.

Referring now to FIG. 10, a battery module 1000 according to the embodiment of the present invention includes multiple battery cells 100 arranged in one direction (including, for example, the lithium secondary battery 100 generally shown in FIG. 1 and FIG. 2, and the detailed aspects illustrated in FIG. 8A, FIG. 8B, FIG. 9A and/or FIG. 9B) and a housing 1061, 1062, 1063, 1064 in which the battery cells 100 are received.

The housing 1061 to 1065 may include a pair of end plates 1061, 1062 facing wide surfaces of the battery cells 100, and side plates 1063 and a bottom plate 1064 each connecting the pair of end plates 1061, 1062 to each other. The side plates 1063 may support side surfaces of each of the battery cells 100 and the bottom plate 1064 may support a bottom surface of each of the battery cells 10. In addition, the pair of end plates 1061, 1062, the side plates 1063 and the bottom plates 1064 may be connected to one another by members, such as bolts 1065 or the like.

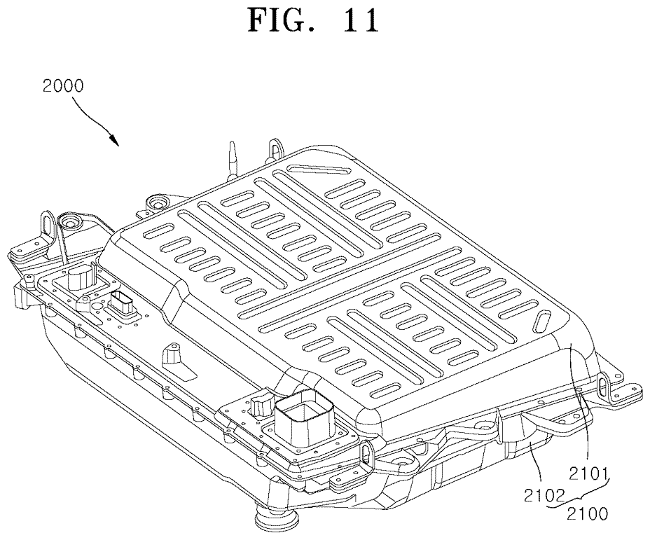

FIG. 11 is a perspective view of a battery pack 2000 according to some embodiments.

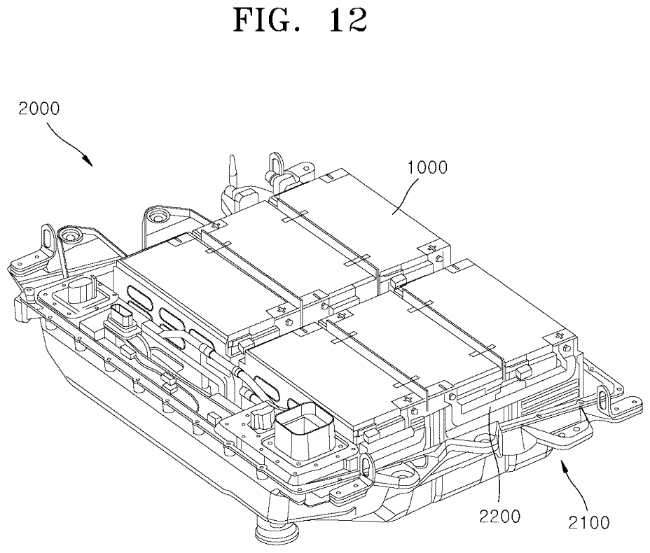

FIG. 12 is a perspective view of the battery pack 2000 according to some embodiments.

The battery pack 2000 may include an aggregate of individual batteries electrically connected to each other and a pack case 2100 receiving the batteries. For convenience of illustration, components, such as a busbar, a cooling unit, and an external terminal for electrical connection of the batteries are omitted.

The battery pack 2000 may include multiple battery modules 1000 (including, for example, the battery modules 1000 illustrated in FIG. 9A and/or FIG. 9B) and a pack case 2100 receiving the battery modules 1000 therein. For example, the pack case 2100 may include first and second pack cases 2101, 2102 coupled to each other to face each other with the multiple battery modules 1000 interposed therebetween. The multiple battery modules 1000 may be electrically connected to each other through busbars 2200 and may be electrically connected to each other in a series/parallel or in a mixed series/parallel manner to achieve required electrical output.

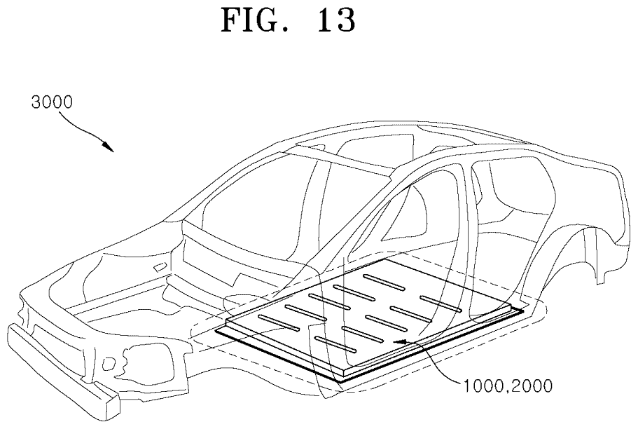

FIG. 13 is a perspective view of a vehicle body of an automobile 3000 according to some embodiments.

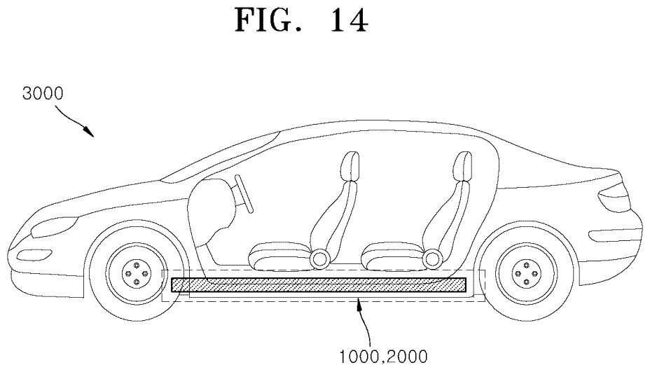

FIG. 14 is a side view of the vehicle body shown in FIG. 13.

The battery pack 2000 according to exemplary embodiments illustrated in FIG. 11 and FIG. 12 may be mounted on the automobile 3000. The automobile 3000 may be, for example, an electric automobile, a hybrid automobile, or a plug-in hybrid automobile. The automobile 3000 may include a four-wheeled automobile or a two-wheeled automobile.

Referring to FIG. 13 and FIG. 14, the automobile 3000 according to some embodiments includes the battery module 1000 according to some embodiments and/or the battery pack 2000 including the battery module 1000. The automobile 3000 may operate by receiving power from the battery module 1000 and/or the battery pack 2000 including the battery modules 1000 according to some embodiments.

Although the present invention has been described with reference to some embodiments and drawings illustrating aspects thereof, the present invention is not limited thereto. Various modifications and variations can be made by those skilled in the art to which the present disclosure belongs within the scope of the technical spirit of the present disclosure and the claims below and their equivalents.

What is claimed is:

1. A mandrel unit comprising:
a mandrel to facilitate winding an electrode assembly secured to one region of the mandrel in one direction; and
a reinforcement member mounted in the one region of the mandrel and securing the electrode assembly to the mandrel.

2. The mandrel unit according to claim 1, wherein the reinforcement member surrounds the one region of the mandrel along an outer circumferential surface of the mandrel, and one end of the reinforcement member and another end of the reinforcement member face each other to form a slit therebetween on the outer circumferential surface of the mandrel when the reinforcement member is mounted on the one region of the mandrel.

3. The mandrel unit according to claim 2, wherein the outer circumferential surface of the mandrel comprises:
a first surface portion including a substantially curved surface; and
a second surface portion including a substantially flat surface and connected to the first surface portion, wherein the reinforcement member surrounds the one region of the mandrel such that the slit is placed on the second surface portion.

4. The mandrel unit according to claim 1, wherein the reinforcement member forms a particular shape based on a temperature in a particular temperature range or a pressure in a particular pressure range.

5. The mandrel unit according to claim 1, wherein
the mandrel comprises a first mandrel and a second mandrel having linearly symmetrical shapes with respect to each other and being spaced apart from each other to face each other, and
the reinforcement member comprises a first reinforcement member mounted on an end portion of one side of the first mandrel and a second reinforcement member mounted on an end portion of one side of the second mandrel.

6. The mandrel unit according to claim 1, wherein
the mandrel comprises a first mandrel and a second mandrel spaced apart from each other by a predetermined distance to face each other and formed in different shapes or sizes, and
the reinforcement member comprises a first reinforcement member mounted on an end portion of one side of the first mandrel and a second reinforcement member mounted on an end portion of one side of the second mandrel.

7. The mandrel unit according to claim 6, wherein the mandrel is rotated in the one direction to allow the electrode assembly to be wound therearound when the electrode assembly is disposed in a predetermined gap between the first mandrel and the second mandrel.

8. The mandrel unit according to claim 1, wherein a width of the reinforcement member is less than or equal to a width of the electrode assembly.

9. The mandrel unit according to claim 1, wherein the electrode assembly is formed by stacking an anode, a cathode, and a separator interposed between the anode and the cathode, and a width of the reinforcement member is less than or equal to a width of the separator and is greater than or equal to a width of the anode.

10. An electrode assembly comprising:
a jellyroll formed by winding a laminate comprising an anode, a cathode, and a separator interposed between the anode and the cathode; and
a reinforcement member placed at a winding core of the jellyroll and supporting the winding core.

11. The electrode assembly according to claim 10, wherein the reinforcement member comprises:
a first reinforcement member placed at an upper portion of the winding core to support an upper shape of the jellyroll; and
a second reinforcement member placed at a lower portion of the winding core to support a lower shape of the jellyroll.

12. The electrode assembly according to claim 11,
wherein the first reinforcement member has a sheet shape with a longer length than a width thereof, opposite ends of the first reinforcement member face each other in a longitudinal direction thereof to form a ring shape, and a first slit is formed towards the second reinforcement member between the opposite ends of the first reinforcement member in the longitudinal direction; and
wherein the second reinforcement member has a sheet shape with a longer length than a width thereof, opposite ends of the second reinforcement member face each other in a longitudinal direction thereof to form a ring shape, and a second slit is formed towards the first reinforcement member formed between the opposite ends of the second reinforcement member in the longitudinal direction.

13. The electrode assembly according to claim 10, wherein the reinforcement member forms a particular shape based on a temperature in a particular temperature range or a pressure in a particular pressure range.

14. The electrode assembly according to claim 10, wherein a width of the reinforcement member is less than or equal to a width of the separator and is greater than or equal to a width of the anode.

15. A secondary battery comprising:
a jellyroll formed by winding a laminate including an anode, a cathode, and a separator interposed between the anode and the cathode into a jellyroll shape; and
a reinforcement member placed at a winding core of the jellyroll and supporting a shape of the winding core.

16. The secondary battery according to claim 15, wherein the reinforcement member comprises:
a first reinforcement member placed at an upper portion of the winding core to support an upper shape of the jellyroll; and
a second reinforcement member placed at a lower portion of the winding core to support a lower shape of the jellyroll.

17. The secondary battery according to claim 16,
wherein the first reinforcement member has a sheet shape with a longer length than a width thereof, opposite ends of the first reinforcement member face each other in a longitudinal direction thereof to form a ring shape, and a first slit is formed towards the second reinforcement member between the opposite ends of the first reinforcement member in the longitudinal direction; and
wherein the second reinforcement member has a sheet shape with a longer length than a width thereof, opposite ends of the second reinforcement member face each other in a longitudinal direction thereof to form a ring shape, and a second slit is formed towards the first reinforcement member formed between the opposite ends of the second reinforcement member in the longitudinal direction.

18. The secondary battery according to claim 15, wherein the reinforcement member forms a particular shape at a temperature in a particular temperature range or a pressure in a particular pressure range.

19. The secondary battery according to claim 15, wherein a width of the reinforcement member is less than or equal to a width of the jellyroll.

20. The secondary battery according to claim 15, wherein a width of the reinforcement member is less than or equal to a width of the separator and greater than or equal to a width of the anode.
